(19) United States
(12) Patent Application Publication
(10) Pub. No.: US 2018/0171049 A1
(43) Pub. Date: Jun. 21, 2018

(54) Methods for Making High Density Polyethylene Compositions

(71) Applicant: ExxonMobil Chemical Patents Inc., Baytown, TX (US)

(72) Inventors: Ching-Tai Lue, Sugarland, TX (US); Phillip T. Matsunaga, Houston, TX (US); David H. McConville, The Woodlands, TX (US); Tae Hoon Kwalk, Somerset, NJ (US)

(21) Appl. No.: 15/806,556

(22) Filed: Nov. 8, 2017

Related U.S. Application Data
(60) Provisional application No. 62/435,301, filed on Dec. 16, 2016.

(51) Int. Cl. C08F 210/02

(52) U.S. Cl. CPC C08F 210/02; C08F 2500/12; C08F 2500/07

(57) ABSTRACT

Methods for making a high density polyethylene composition are provided. The methods can include contacting ethylene and at least one non-ethylene comonomer with a catalyst system in a gas phase reactor in the presence of hydrogen at an ethylene partial pressure of 100 psi or more to produce a polyethylene copolymer. In one or more embodiments, the catalyst system can include one or more bis amides. The resulting polyethylene copolymer can have a density of about 0.945 g/cm³ or more; a melt index (I₂) of about 5 dg/min to about 50 dg/min; a melt index ratio (I₂₁/I₂) of about 20 to about 35; and a molecular weight distribution of about 3.0 to about 10.

### CROSS REFERENCE TO RELATED APPLICATIONS

This application claims the benefit of Ser. No. 62/435,301, filed Dec. 16, 2016, the disclosures of which is hereby incorporated by reference in its entirety.

### FIELD OF THE INVENTION

The present disclosure generally relates to high density polyethylene compositions and methods for making same.

### BACKGROUND OF THE INVENTION

Polyethylene (“PE”) resins are used in a wide variety of products and applications. The density and melt index of a resin usually dictate its end uses and applications. The polymerization process for making the resin, whether it is a solution, slurry, or gas phase process, and the catalyst system employed in the process, greatly impact the density and melt index of the resin.

In gas phase polymerization processes, Ziegler-Natta (“ZN”) catalysts, for example, have been able to produce polyethylene films with high tensile strength, impact strength, tear resistance, film stiffness, and can be drawn down to thin gauges. In molding applications, conventional ZN-based resins are known to provide excellent moldability, high stiffness, fast molding cycles, and low warpage. These resins also typically have low taste and odor, and offer excellent Environmental Strength Stress Crack Resistance (“ESCR”) and toughness over a broad temperature range. End-use applications typically include tote boxes, dish pans, tumbled lids, crates, etc.

Metallocene catalysts have been known to provide polyethylene products with a higher level and improved balance of properties as opposed to conventional ZN-catalyzed PE resins. Resins produced from metallocene catalysts have also been able to possess outstanding toughness, clarity, and improved processability compared to conventionally catalyzed resins. Metallocene catalysts have also been known to control polymer molecular structure, allowing independent manipulation of molecular weight distribution (“MWD”), comonomer composition distribution, and the branching of the polymer.

Compared to non-metallocenes, metallocene catalysts require significantly lower comonomer and hydrogen to achieve the same density, resulting in less comonomer consumption per ton of resin produced. Lower levels of comonomer in the resin, combined with lower extractability levels resulting from the narrow compositional distribution, make these metallocene resins less “sticky” in the reactor. For operators, these benefits mean improved operations, cost savings, superior product quality, and a range of product capability.

Thus, there is still a need, however, for gas phase processes to produce commercially viable polyolefins having improved physical and chemical properties.

### SUMMARY OF THE INVENTION

In a class of embodiments, the invention provides for a method for making a high density polyethylene composition, the method comprising: contacting ethylene and at least one non-ethylene comonomer with catalyst system in a gas phase reactor in the presence of hydrogen at an ethylene partial pressure of 100 psi or more to produce a polyethylene copolymer having: a density of about 0.945 g/cm³ or more; a melt index (12) of about 5 dg/min to about 50 dg/min; a melt flow ratio (I₂₁/I₂) of about 20 to about 35; a weight average molecular weight distribution of about 3.0 to about 10; and a spiral flow in accordance with ASTM D 3123-98 at 1,200 psi injection pressure that is greater than 0.90*MI (I₂)+21 inches, and recovering the polyethylene copolymer; wherein the catalyst system comprises bis amides.

In another class of embodiments, the invention provides for a method for making a high density polyethylene composition having enhanced injection moldability, the method comprising: contacting ethylene and at least one non-ethylene comonomer with a catalyst system in a gas phase reactor in the presence of hydrogen at an ethylene partial pressure of 100 psi or more to produce a polyethylene copolymer having: a density of about 0.945 g/cm³ or more; a melt index (I₂) of about 5 dg/min to about 50 dg/min; a melt flow ratio (I₂₁/I₂) of about 20 to about 35; a weight average molecular weight distribution of about 3.0 to about 10; a spiral flow in accordance with ASTM D 3123-98 at 1,200 psi injection pressure that is greater than 0.89*MI (I₂)+23 inches, and recovering the polyethylene copolymer; wherein the catalyst system comprises bis(2-(pentamethyl phenyl amido)ethyl) amine zirconium dibenzyl and is supported on fumed silica with methylalumoxane.

In yet another embodiment, the invention provides for a method for making a high density polyethylene composition, the method comprising: contacting ethylene and at least one non-ethylene comonomer with a catalyst system in a gas phase reactor in the presence of hydrogen at an ethylene partial pressure of 100 psi or more to produce a polyethylene copolymer having: a density of about 0.95 g/cm³ to about 0.97 g/cm³; a melt index (I₂) of about 5.0 dg/min to about 19 dg/min; a melt flow ratio (I₂₁/I₂) of about 29 to about 35; a weight average molecular weight distribution of about 6.0 to about 9.5; a spiral flow in accordance with ASTM D 3123-98 at 1,200 psi injection pressure that is greater than 0.89*MI (I₂)+23 inches, and recovering the polyethylene copolymer; wherein the catalyst system comprises bis(2-(pentamethyl phenyl amido)ethyl) amine zirconium dibenzyl and are supported on fumed silica with methylalumoxane.

### BRIEF DESCRIPTION OF THE DRAWINGS

FIG. 1 is a graphical depiction of the polydisperity of Inventive Sample 1 versus a comparative ZN based resin of an equivalent melt index.

FIG. 2 is a graphical depiction of the polydisperity of Inventive Sample 2 versus a comparative ZN based resin of an equivalent melt index.

FIG. 3 is a graphical depiction of the polydisperity of Inventive Sample 3 versus a comparative ZN based resin of an equivalent melt index.

FIG. 4 is a plot of spiral flow versus melt index for each of the Inventive Samples 1-3 and Comparative Samples ZN-1 to ZN-3.

FIG. 5 is a plot of weight average molecular weight (Mw) versus spiral for each of the Inventive Samples 1-3 and Comparative Samples ZN-1 to ZN-3.

FIG. 6 is a plot of density versus flex modulus for each of the Inventive Samples 1-3 and Comparative Samples ZN-1 to ZN-3.

FIG. 7 is a plot of tensile impact at −40° C. versus Mw for each of the Inventive Samples 1-3 and Comparative Samples ZN-1 to ZN-3.

FIG. 8 is a plot of tensile impact at −40° C. versus spiral flow for each of the Inventive Samples 1-3 and Comparative Samples ZN-1 to ZN-3.

FIG. 9 is a plot comparing pail drop to Mw for each of the Inventive Samples 1-3 and Comparative Samples ZN-1 to ZN-3.

FIG. 10 is a plot comparing pail drop to spiral flow at 1600 psi for each of the Inventive Samples 1-3 and Comparative Samples ZN-1 to ZN-3.

FIG. 11 is a plot comparing pail drop to IZOD for each of the Inventive Samples 1-3 and Comparative Samples ZN-1 to ZN-3.

FIG. 12 is a plot comparing pail drop to tensile impact for each of the Inventive Samples 1-3 and Comparative Samples ZN-1 to ZN-3.

### DETAILED DESCRIPTION

Before the present compounds, components, compositions, and/or methods are disclosed and described, it is to be understood that unless otherwise indicated, this invention is not limited to specific compounds, components, compositions, reactants, reaction conditions, ligands, metallocene structures, or the like, as such may vary, unless otherwise specified. It is also to be understood that the terminology used herein is for the purpose of describing particular embodiments only and is not intended to be limiting.

Methods for making a polyethylene having enhanced injection moldability are provided. The polyethylene is a high density polyethylene (HDPE) made using a single site Group-15 containing catalyst. As used herein, all reference to the Periodic Table of the Elements and groups thereof is to the NEW NOTATION published in HAWLEY'S CONDENSED CHEMICAL DICTIONARY, Thirteenth Edition, John Wiley & Sons, Inc., (1997) (reproduced there with permission from IUPAC), unless reference is made to the Previous IUPAC form denoted with Roman numerals (also appearing in the same), or unless otherwise noted.

The HDPE exhibits significantly improved strength characteristics compared to HDPEs made using conventional Ziegler Natta (“ZN”) products of equivalent melt index. The HDPEs show a higher polydisperity index (“PDI,” “Mw/Mn,” or “MWD”) and broader melt flow ratio (“MFR”) (I₂₁/I₂) than those of ZN-based commercial products having equivalent MI (12). The HDPEs also provide significantly improved injection moldability over ZN-based commercial products having equivalent MI (12), without a sacrifice in the desirable mechanical properties that were thought to be had only through ZN-based products.

The terms “polyethylene” and “polyethylene polymer” refer to a polymer having at least 50 wt % ethylene-derived units, preferably at least 70 wt % ethylene-derived units, more preferably at least 80 wt % ethylene-derived units, or 90 wt % ethylene-derived units, or 95 wt % ethylene-derived units, or 100 wt % ethylene-derived units, based upon the total weight of the polymer. The polyethylene polymer can thus be a homopolymer or a copolymer, including a terpolymer, having one or more other monomeric units. Polyethylene described herein can, for example, include at least one or more other olefin(s) and/or comonomer(s). Suitable comonomers include α-olefins, such as C₃-C₂₀ α-olefins or C₃-C₁₂ α-olefins. The α-olefin comonomer can be linear, branched, and/or cyclic, and two or more comonomers can be used, if desired. Examples of suitable comonomers include linear C₃-C₁₂ α-olefins, and α-olefins having one or more C₁-C₃ alkyl branches or an aryl group. Specific examples include: propylene; 3-methyl-1-butene; 3,3 -dimethyl-1-butene; 1-pentene; 1-pentene with one or more methyl, ethyl, or propyl substituents; 1-hexene with one or more methyl, ethyl, or propyl substituents; 1-heptene with one or more methyl, ethyl, or propyl substituents; 1-octene with one or more methyl, ethyl, or propyl substituents; 1-nonene with one or more methyl, ethyl or propyl substituents; ethyl, methyl, or dimethyl-substituted 1-decene; 1-dodecene; styrene; and mixtures thereof. It should be appreciated that the list of comonomers above is merely exemplary, and is not intended to be limiting. Preferred comonomers also include propylene, 1-butene, 1-pentene, 4-methyl-l-pentene, 1-hexene, 1-octene, styrene, and mixtures thereof.

Other useful comonomers include conjugated and non-conjugated dienes, which can be included in minor amounts in terpolymer compositions. Non-conjugated dienes useful as co-monomers preferably are straight chain, hydrocarbon diolefins, or cycloalkenyl-substituted alkenes, having 6 to 15 carbon atoms. Suitable non-conjugated dienes include, for example: (a) straight chain acyclic dienes, such as 1,4-hexadiene and 1,6-octadiene; (b) branched chain acyclic dienes, such as 5-methyl-1,4-hexadiene; 3,7-dimethyl-1,6-octadiene; and 3,7-dimethyl-1,7-octadiene; (c) single ring alicyclic dienes, such as 1,4-cyclohexadiene; 1,5-cyclo-octadiene and 1,7-cyclododecadiene; (d) multi-ring alicyclic fused and bridged ring dienes, such as tetrahydroindene; norbornadiene; methyl-tetrahydroindene; dicyclopentadiene (DCPD); bicyclo-(2.2.1)-hepta-2,5-diene; alkenyl, alkylidene, cycloalkenyl and cycloalkylidene norbornenes, such as 5-methylene-2-norbornene (MNB), 5-propenyl-2-norbornene, 5-isopropylidene-2-norbornene, 5-(4-cyclopentenyl)-2-norbornene, 5-cyclohexylidene-2-norbornene, and 5-vinyl-2-norbornene (VNB); and (e) cycloalkenyl-substituted alkenes, such as vinyl cyclohexene, allyl cyclohexene, vinyl cyclooctene, 4-vinyl cyclohexene, allyl cyclodecene, and vinyl cyclododecene. Of the non-conjugated dienes typically used, the preferred dienes are dicyclopentadiene, 1,4-hexadiene, 5-methylene-2-norbornene, 5-ethylidene-2-norbornene, and tetracyclo-(11,12)-5,8-dodecene. Particularly preferred diolefins are 5-ethylidene-2-norbornene (ENB), 1,4-hexadiene, dicyclopentadiene (DCPD), norbornadiene, and 5-vinyl-2-norbornene (VNB).

### Catalysts and Catalyst Systems

The terms “catalyst” and “catalyst system” are intended to be used interchangeably and refer to any one or more polymerization catalysts, activators, supports/carriers, or combinations thereof, unless otherwise stated. The catalyst for making the polyethylene described herein can be or can include one or more Group 15-containing catalysts. The “Group 15-containing catalyst” can include Group 3 to Group 12 metal complexes, wherein the metal has 2 to 8 coordination sites, the coordinating moiety or moieties including at least two Group 15 atoms, and up to four Group 15 atoms. For example, the Group 15-containing catalyst component can be a complex of a Group 4 metal and from one to four ligands such that the Group 4 metal is at least 2 coordinate, the coordinating moiety or moieties including at least two nitrogens. The Group 15-containing catalyst component can be a bis amide complex of a Group 4 metal bound to at least two nitrogens. Representative Group 15-containing compounds are disclosed in WO 99/01460; and EP 0 893 454 A; U.S. Pat. Nos. 5,318,935; 5,889,128; 6,333,389; and 6,271,325.

In one embodiment, the Group 15-containing catalyst can include a Group 3 to 14 metal atom, preferably a Group 3 to 7, more preferably a Group 4 to 6, and even more preferably a Group 4 metal atom, bound to at least one leaving group and also bound to at least two Group 15 atoms, at least one of which is also bound to a Group 15 or 16 atom through another group.

In another embodiment, at least one of the Group 15 atoms is also bound to a Group 15 or 16 atom through another group which may be a C₁ to C₂₀ hydrocarbon group, a heteroatom containing group, silicon, germanium, tin, lead, or phosphorus, wherein the Group 15 or 16 atom may also be bound to nothing or a hydrogen, a Group 14 atom containing group, a halogen, or a heteroatom containing group, and wherein each of the two Group 15 atoms are also bound to a cyclic group and may optionally be bound to hydrogen, a halogen, a heteroatom or a hydrocarbyl group, or a heteroatom containing group.

In another embodiment, the Group 15 containing metal compound can be represented by at least one of the following structures:

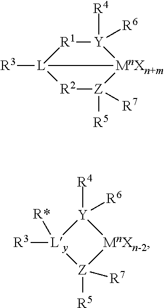

wherein: M is a Group 3 to 12 transition metal or a Group 13 or 14 main group metal, preferably a Group 4, 5, or 6 metal, and more preferably a Group 4 metal, and most preferably zirconium, titanium or hafnium;
each X is independently a leaving group, preferably, an anionic leaving group, and more preferably hydrogen, a hydrocarbyl group, a heteroatom or a halogen, and most preferably an alkyl;
y is 0 or 1 (when y is 0 group L′ is absent);
n is the oxidation state of M, preferably +3, +4, or +5, and more preferably +4;
m is the formal charge of the YZL or the YZL′ ligand, preferably 0, −1, −2 or −3, and more preferably −2;
L is a Group 15 or 16 element, preferably nitrogen;
L′ is a Group 15 or 16 element or Group 14 containing group, preferably carbon, silicon or germanium;
Y is a Group 15 element, preferably nitrogen or phosphorus, and more preferably nitrogen;
Z is a Group 15 element, preferably nitrogen or phosphorus, and more preferably nitrogen;
R¹ and R² are independently a C₁ to C₂₀ hydrocarbon group, a heteroatom containing group having up to twenty carbon atoms, silicon, germanium, tin, lead, or phosphorus, preferably a C₂ to C₂₀ alkyl, aryl or aralkyl group, more preferably a linear, branched or cyclic C₂ to C₂₀ alkyl group, most preferably a C₂ to C₆ hydrocarbon group;
R³ is absent or a hydrocarbon group, hydrogen, a halogen, a heteroatom containing group; preferably a linear, cyclic or branched alkyl group having 1 to 20 carbon atoms, more preferably R³ is absent, hydrogen or an alkyl group, and most preferably hydrogen;
R⁴ and R⁵ are independently an alkyl group, an aryl group, substituted aryl group, a cyclic alkyl group, a substituted cyclic alkyl group, a cyclic aralkyl group, a substituted cyclic aralkyl group or multiple ring system, preferably having up to 20 carbon atoms, more preferably between 3 and 10 carbon atoms, and even more preferably a C₁ to C₂₀ hydrocarbon group, a C₁ to C₂₀ aryl group or a C₁ to C₂₀ aralkyl group, or a heteroatom containing group, for example PR³, where R is an alkyl group;
R¹ and R² may be interconnected to each other, and/or R⁴ and R⁵ may be interconnected to each other;
R⁶ and R⁷ are independently absent, or hydrogen, an alkyl group, halogen, heteroatom or a hydrocarbyl group, preferably a linear, cyclic or branched alkyl group having 1 to 20 carbon atoms, more preferably absent; and
R* is absent, or is hydrogen, a Group 14 atom containing group, a halogen, a heteroatom containing group.

By “formal charge of the YZL or YZL′ ligand”, it is meant that the charge of the entire ligand absent the metal and the leaving groups X.

By “R¹ and R² may also be interconnected” it is meant that R¹ and R² may be directly bound to each other or may be bound to each other through other groups. By “R⁴ and R⁵ may also be interconnected” it is meant that R⁴ and R⁵ may be directly bound to each other or may be bound to each other through other groups.

An alkyl group may be a linear, branched alkyl radicals, or alkenyl radicals, alkynyl radicals, cycloalkyl radicals or aryl radicals, acyl radicals, aroyl radicals, alkoxy radicals, aryloxy radicals, alkylthio radicals, dialkylamino radicals, alkoxycarbonyl radicals, aryloxycarbonyl radicals, carbomoyl radicals, alkyl- or dialkyl-carbamoyl radicals, acyloxy radicals, acylamino radicals, aroylamino radicals, straight, branched or cyclic, alkylene radicals, or combination thereof An aralkyl group is defined to be a substituted aryl group.

In another embodiment, R⁴ and R⁵ are independently a group represented by the following:

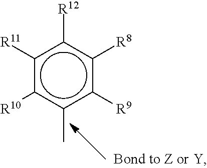

wherein R⁸ to R¹² are each independently hydrogen, a C₁ to C₄₀ alkyl group, a halide, a heteroatom, a heteroatom containing group containing up to 40 carbon atoms, preferably a C₁ to C₂₀ linear or branched alkyl group, preferably a methyl, ethyl, propyl, or butyl group, any two R groups may form a cyclic group and/or a heterocyclic group. The cyclic groups may be aromatic. In a preferred embodiment, R⁹, R¹⁰ and R¹² are independently a methyl, ethyl, propyl, or butyl group (including all isomers), in a preferred embodiment R⁹, R¹⁰ and R¹² are methyl groups, and R⁸ and R¹¹ are hydrogen.

In another embodiment, R⁴ and R⁵ are both a group represented by the following:

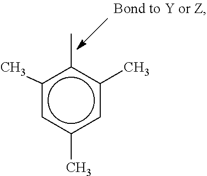

wherein M is a Group 4 metal, preferably zirconium, titanium or hafnium;
each of L, Y, and Z is nitrogen;
each of R¹ and R² is —CH₂—CH₂—;
R³ is hydrogen; and
R⁶ and R⁷ are absent.

In another embodiment, the Group 15 containing metal compound is represented by:

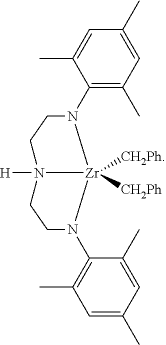

The Group 15-containing catalysts can be prepared by methods known in the art, such as those disclosed in EP 0 893 454 A, U.S. Pat. Nos. 5,889,128 and 6,271,325.

A preferred direct synthesis of these compounds comprises reacting the neutral ligand, (see, for example, YZL or YZL′ shown above) with MⁿXₙ (M is a Group 3 to 14 metal, n is the oxidation state of M, each X is an anionic group), such as halide, in a non-coordinating or weakly coordinating solvent, such as ether, toluene, xylene, benzene, methylene chloride, and/or hexane or other solvent having a boiling point above 60° C., at about 20 to about 150° C. (preferably, 20 to 100° C.), preferably for 24 hours or more, then treating the mixture with an excess (such as four or more equivalents) of an alkylating agent, such as methyl magnesium bromide in ether. The magnesium salts are then removed by filtration and the metal complex isolated.

In one embodiment, the Group 15-containing metal catalyst is prepared by a method comprising reacting a neutral ligand, (see, for example, YZL or YZL' shown above) with a compound represented by the formula MⁿXₙ (where M is a Group 3 to 14 metal, n is the oxidation state of M, each X is an anionic leaving group) in a non-coordinating or weakly coordinating solvent, at about 20° C. or above, preferably at about 20 to about 100° C., then treating the mixture with an excess of an alkylating agent, then recovering the metal complex. In a preferred embodiment the solvent has a boiling point above 60° C., such as toluene, xylene, benzene, and/or hexane. In another embodiment the solvent comprises ether and/or methylene chloride, either being preferable.

Useful activators can include alumoxane or modified alumoxane, or ionizing activators, neutral or ionic, such as tri (n-butyl) ammonium tetrakis(pentafluorophenyl) boron or a trisperfluorophenyl boron metalloid precursor. A preferred activator used with the catalyst compositions described herein is methylaluminoxane (“MAO”). The MAO activator can be associated with or bound to a support, either in association with the catalyst component or separate from the catalyst component, such as described by Gregory G. Hlatky, Heterogeneous Single-Site Catalysts for Olefin Polymerization, 100(4) CHEMICAL REVIEWS 1347-1374 (2000).

There are a variety of methods for preparing alumoxane and modified alumoxanes. Non-limiting examples of which are described in U.S. Pat. Nos. 4,665,208; 4,952,540; 5,091,352; 5,206,199; 5,204,419; 4,874,734; 4,924,018; 4,908,463; 4,968,827; 5,308,815; 5,329,032; 5,248,801; 5,235,081; 5,157,137; 5,103,031; 5,391,793; 5,391,529; 5,693,838; and EP 0 279 586 B; EP 0 561 476 A; EP 0 594 218 A; and WO 94/10180.

Ionizing compounds can contain an active proton or some other cation associated with but not coordinated or only loosely coordinated to the remaining ion of the ionizing compound. Such compounds and the like are described in EP 0 570 982 A; EP 0 520 732 A; EP 0 495 375 A; EP 0 426 637 A; EP 0 500 944 A; EP 0 277 003 A; and EP 0 277 004 A; and U.S. Pat. Nos. 5,153,157; 5,198,401; 5,066,741; 5,206,197; 5,241,025; 5,387,568; 5,384,299; and 5,502,124.

Combinations of activators are also contemplated, for example, alumoxanes and ionizing activators in combination, see for example, WO Publication Nos. WO 94/07928 and WO 95/14044 and U.S. Pat. Nos. 5,153,157 and 5,453,410.

The terms “support” or “carrier” are used interchangeably herein and refer to any support material, preferably, a porous support material, including inorganic or organic support materials. The term “supported” as used herein refers to one or more compounds that are deposited on, contacted with, vaporized with, bonded to, or incorporated within, adsorbed or absorbed in, or on, a support or carrier. In some embodiments, the support material can be a porous support material. Non-limiting examples of support materials include inorganic oxides and inorganic materials, and in particular, such materials as talc, clay, silica, alumina, magnesia, zirconia, iron oxides, boria, calcium oxide, zinc oxide, barium oxide, thoria, aluminum phosphate gel, and polymers such as polyvinylchloride and substituted polystyrene, functionalized or crosslinked organic supports such as polystyrene divinyl benzene polyolefins or polymeric compounds, and mixtures thereof, and graphite, in any of its various forms. Non-limiting examples of inorganic support materials also include inorganic oxides and inorganic chlorides.

Examples of supporting a catalyst system are described in, for example, U.S. Pat. Nos. 4,701,432; 4,808,561; 4,912,075; 4,925,821; 4,937,217; 5,008,228; 5,238,892; 5,240,894; 5,332,706; 5,346,925; 5,422,325; 5,466,649; 5,466,766; 5,468,702; 5,529,965; 5,554,704; 5,629,253; 5,639,835; 5,625,015; 5,643,847; 5,665,665; 5,468,702; and 6,090,740; and WO Publication Nos. WO 95/32995; WO 95/14044; WO 96/06187; and WO 97/02297.

### Hydrogen

Hydrogen gas can be present during the polymerization of the ethylene and optional comonomer(s) to control the final properties of the polyethylene, such as described in Polypropylene Handbook 76-78 (Hamer Publishers, 1996). Increasing concentrations (partial pressures) of hydrogen can increase the melt index ratio (“MIR”) or MFR and/or melt index of the polyolefin generated. The MFR or MI can thus be influenced by the hydrogen concentration. The amount of hydrogen in the polymerization can be expressed as a mole ratio relative to the total polymerizable monomer, for example, ethylene, or a blend of ethylene and octane, hexene, or propylene. The amount of hydrogen used in the polymerization process of the polyethylene can be sufficient to produce the desired MI, and/or MIR of the final polyethylene resin. In one embodiment, the mole ratio of hydrogen to total monomer (H2:monomer) is in a range of from greater than 0.0001 in one embodiment, and from greater than 0.0005 in another embodiment, and from greater than 0.001 in yet another embodiment, and less than 10 in yet another embodiment, and less than 5 in yet another embodiment, and less than 3 in yet another embodiment, and less than 0.10 in yet another embodiment, where a desirable range can comprise any combination of any upper mole ratio limit with any lower mole ratio limit described herein. Expressed another way, the amount of hydrogen in the reactor at any time can range to up to 5,000 ppm, up to 4,000 ppm in another embodiment, and up to 3,000 ppm in yet another embodiment, and between 50 ppm and 5,000 ppm in yet another embodiment, and between 100 ppm and 2,000 ppm in yet another embodiment.

### Ethylene Partial Pressure

The ethylene partial pressure within the reactor can be from a low of about 750 kPa, about 775 kPa, about 800 kPa, about 825 kPa, about 850 kPa, about 875 kPa, or about 900 kPa to a high of about 1,500 kPa, about 1,700 kPa, about 1,900 kPa, about 2,100 kPa, about 2,300 kPa, about 2,500 kPa, or about 2,700 kPa during polymerization of the ethylene and the comonomer. For example, the ethylene partial pressure can be from about 825 kPa to about 1,800 kPa, from about 750 kPa to about 1,500 kPa, from about 1,000 kPa to about 2,200 kPa, from about 800 kPa to about 1,400 kPa, or from about 1,200 kPa to about 1,750 kPa. In another example, the ethylene partial pressure can be from about 1,400 kPa to about 1,600 kPa, from about 1,450 kPa to about 1,550 kPa, from about 1,300 kPa to about 1,450 kPa, from about 1,450 kPa to about 1,525 kPa, or from about 1,500 kPa to about 1,575 kPa.

If desired, the molar ratio of the one or more comonomers to ethylene can range from a low of about 0.01, about 0.0125, or about 0.015 to a high of about 0.017, about 0.0185, or about 0.02. For example, the molar ratio of the one or more comonomers to ethylene can range from about 0.01 to about 0.02, from about 0.012 to about 0.019, from about 0.013 to about 0.018, from about 0.014 to about 0.0175, or a from about 0.014 to about 0.18. In another example, the molar ratio of the one or more comonomers to ethylene can range from at least 0.012, at least 0.013, at least 0.014, at least 0.015, or at least 0.016 and less than 0.02, less than 0.018, less than 0.017, or less than 0.0165.

### Polymerization Processes

Generally, a conventional gas phase, fluidized bed polymerization process for producing polyethylene and other types of polyolefins is conducted by passing a gaseous stream containing ethylene and optionally, one or more comonomers continuously through a fluidized bed reactor under reactive conditions and in the presence of one or more catalysts at a velocity sufficient to maintain the bed of solid particles in a suspended condition. A continuous cycle is employed where the cycling gas stream, otherwise known as a recycle stream or fluidizing medium, is heated in the reactor by the heat of polymerization. The hot gaseous stream, also containing unreacted gaseous (co)monomer, is continuously withdrawn from the reactor, compressed, cooled and recycled into the reactor. Product is withdrawn from the reactor and make-up (co)monomer is added to the system, e.g., into the recycle stream or reactor, to replace the polymerized monomer.

An industrial-scale reactor that may be utilized is capable of producing greater than 227 kg of polymer per hour (Kg/hr) to about 90,900 Kg/hr or higher of polymer. The reactor may be capable of producing greater than 455 Kg/hr, or greater than 4540 Kg/hr, or greater than 11,300 Kg/hr, or greater than 15,900 Kg/hr, or greater than 22,700 Kg/h, or greater than 29,000 Kg/hr, or greater than 45,500 Kg/hr. Such reactors, for example, can have an inner diameter of at least about 6 inches in the region where the fluid bed resides, and is generally greater than about 8 feet on the industrial-scale, and can exceed 15 or 18 feet.

The conditions for polymerizations vary depending upon the monomers, catalysts and equipment availability. The specific conditions are known or can be readily determined by those skilled in the art. For example, the temperatures can range from about −10° C. to about 120° C., often about 15° C. to about 110° C. Pressures can be within the range of about 0.1 bar to about 100 bar, such as about 5 bar to about 50 bar, for example. Additional details of the polymerization process and reaction conditions can be found in U.S. Pat. No. 6,627,713.

The gas phase process can be operated in a condensed mode, where an inert condensable fluid is introduced to the process to increase the cooling capacity of the reactor system. These inert condensable fluids are referred to as induced condensing agents or ICA's. Condensed mode processes are further described in U.S. Pat. Nos. 5,342,749 and 5,436,304.

Additional processing details are more fully described in, for example, U.S. Pat. Nos. 4,543,399; 4,588,790; 5,028,670; 5,317,036; 5,352,749; 5,405,922; 5,436,304; 5,453,471; 5,462,999; 5,616,661; 5,627,242; 5,665,818; 5,668,228; 5,677,375; 5,804,678; 6,362,290; and 6,689,847.

During polymerization, supported non-metallocene catalysts often display a kinetic profile characterized by a very high initial ethylene uptake (with associated temperature increase) followed by a fast decay in ethylene uptake or catalyst deactivation. This behavior can have a detrimental impact on the overall activity of the catalyst in processes involving residence times that are much longer than the catalyst lifetime. It has been found that the hafnium (Hf) derivative of a bisamide catalyst (HN3Hf) has a different kinetic profile and a much longer half-life than its Zr analogue. For a short polymerization run (30 min.), the Zr catalyst has a measured activity of 4,000 g/mmol·atm·h whereas the Hf derivative has a measured activity of 2,900 g/mmol·atm·h under the same conditions. If the polymerization run is continued for 1 hour, however, the Hf derivative has the higher measured activity because it has remained active throughout the run, whereas the activity of the Zr derivative has decayed dramatically before the end of the run. This difference is even more apparent at higher polymerization temperatures. It has, therefore, been observed that the use of supported Hf derivatives of non-metallocene catalysts can lead to more controlled polymerization reactions which produce higher overall activity than the Zr derivatives for processes with longer residence times.

### Polymer Properties

The polyethylene can have a “melt flow ratio” or “melt index ratio” (I₂₁/I₂) ranging from about 20 to about 35, more preferably from about 20 to about 30, or from about 25 to about 35, or from about 28 to about 35. The melt flow ratio (I₂₁/I₂) also can range from a low of about 20, 22, or 23 to a high of about 28, 31, or 35.

Melt indexes are reported in units of grams per 10 minutes (g/10 min) or equivalently decigrams per minute (dg/min). I_{2.16} or I₂ is the melt index of the polymer measured according to ASTM D-1238-57T, condition I_{21.6} or I₂₁ is the melt index of the polymer measured according to ASTM D-1238-57T, condition F. I_{21.6} is also sometimes termed the “high load melt index” or “HLMI.” The polyethylene can have a melt index (I₂) of about 5 dg/min to about 50 dg/min. The melt index (I2) also can range from a low of about 5 dg/min, 10 dg/min, or 15 dg/min to as high of about 20 dg/min, 35 dg/min, 40 dg/min or 50 dg/min.

The polyethylene can have a density of about 0.945g/cm³ or more. Polymer density (g/cm³) is determined using a compression molded sample, cooled at 15° C. per hour, and conditioned for 40 hours at about 23° C. according to ASTM D1505-68 and ASTM D1928, Procedure C.

For example, the polyethylene can have a density that ranges from a low of about 0.945 g/cm³, about 0.948 g/cm³, about 0.950 g/cm³ to a high of about 0.955 g/cm³, about 0.960 g/cm³, or about 0.970 g/cm³. The polyethylene also can have a density of about 0.951 g/cm³ to about 0.966 g/cm³.

The terms “polydispersity index” or “PDI” means the same thing as “molecular weight distribution” and “MWD.” The MWD is the ratio of weight-average molecular weight (Mw) to number-average molecular weight (Mn), i.e., Mw/Mn. The weight average (Mw), number average (Mn), and z-average (Mz) molecular weights can be measured using gel permeation chromatography (GPC), also known as size exclusion chromatography (SEC). These measurements carry the unit grams per mole or g/mol. This technique utilizes an instrument containing columns packed with porous beads, an elution solvent, and detector in order to separate polymer molecules of different sizes. Measurement of molecular weight by SEC is well known in the art and is discussed in more detail in, for example, Slade, P. E. Ed., Polymer Molecular Weights Part II, Marcel Dekker, Inc., NY, (1975) 287-368; Rodriguez, F., Principles of Polymer Systems 3rd ed., Hemisphere Pub. Corp., NY, (1989) 155-160; U.S. Pat. No. 4,540,753; and Verstrate et al., Macromolecules, vol. 21, (1988) 3360; T. Sun et al., Macromolecules, Vol. 34, (2001) 6812-6820.

The polyethylene can have a weight average molecular weight (Mw), in g/mol, from a low of about 25,000, about 30,000, about 35,000, or about 65,000 to a high of about 70,000, about 75,000, or about 80,000. For example, the Mw of the polyethylene can be from about 25,000 to about 78,000, from about 28,000 to about 75,000, from about 30,000 to about 70,000, from about 35,000 to about 65,000, from about 40,000 to about 63,000, or from about 45,000 to about 65,000.

The polyethylene can have a number average molecular weight (Mn), in g/mol, of from a low of about 10,000, about 15,000, or about 20,000 to a high of about 25,000, about 35,000, or about 50,000. For example, the Mn of the polyethylene can be from about 12,000 to about 42,000, from about 17,000 to about 40,000, from about 17,000 to about 33,000, from about 20,000 to about 30,000, or from about 25,000 to about 35,000.

The polyethylene can have a MWD of about 3.0 to about 10. For example, the polyethylene can have a MWD that ranges from a low of about 3.0, 3.5, or 4.0 to a high of about 6.0, 7.5, or 10.

The polyethylene can have a ratio of z-average molecular weight to weight average molecular weight (Mz/Mw) of from a low of about 2.1, about 2.2, or about 2.3 to a high of about 2.4, about 2.5, about 2.6, or about 2.7. For example, the polyethylene can have a Mz/Mw of about 2.1 to about 2.7, about 2.1 to about 2.6, about 2.2 to about 2.5, about 2.3 to about 2.6, about 2.6 to about 2.9, or about 2.4 to about 2.8.

The polyethylene can have an Environmental Stress Crack Resistance (F50, IGEPAL 10%) (“ESCR”) of at least 50 hours, or at least 60 hours, or at least 70 hours or at least 80 hours or at least 90 hours or at least 100 hours. All ESCR values cited herein are measured in accordance to ASTM D 1693 condition B, 10% IGEPAL™ F50 values, and are given in units of hours. IGEPAL™ is a nonylphenoxy poly(ethylenoxy)ethanol surfactant available from Rhone Polenc, Cranbury, N.J.

The polyethylene can have a spiral flow in accordance with ASTM D 3123-98 at 700 psi injection pressure that is greater than 0.70*MI (I₂)+14 inches. The polyethylene can have a spiral flow in accordance with ASTM D 3123-98 at 1,200 psi injection pressure that is greater than 0.90*MI (I₂)+21 inches. The polyethylene can have a spiral flow in accordance with ASTM D 3123-98 at 1,700 psi injection pressure that is greater than 0.89*MI (I₂)+30 inches.

### End Uses

The polyethylene can be suitable for such articles as films, fibers and nonwoven fabrics, extruded articles, and molded articles. Examples of films include blown or cast films formed by coextrusion or by lamination useful as shrink film, cling film, stretch film, sealing films, oriented films, snack packaging, heavy duty bags, grocery sacks, baked and frozen food packaging, medical packaging, industrial liners, membranes, etc. Examples of fibers include melt spinning, solution spinning and melt blown fiber operations for use in woven or non-woven form to make filters, diaper fabrics, hygiene products, medical garments, geotextiles, etc. Examples of extruded articles include tubing, medical tubing, wire and cable coatings, pipes, geomembranes, pond liners, etc. Examples of molded articles include single and multi-layered constructions in the form of bottles, tanks, large hollow articles, rigid food containers, toys, etc. Examples of injection molding applications include crates, containers, bins, pails, housewares, food containers, base cups, drink cups, etc.

### EXAMPLES

It is to be understood that while the invention has been described in conjunction with the specific embodiments thereof, the foregoing description is intended to illustrate and not limit the scope of the invention. Other aspects, advantages and modifications will be apparent to those skilled in the art to which the invention pertains.

Therefore, the following examples are put forth so as to provide those skilled in the art with a complete disclosure and description and are not intended to limit the scope of that which the inventors regard as their invention.

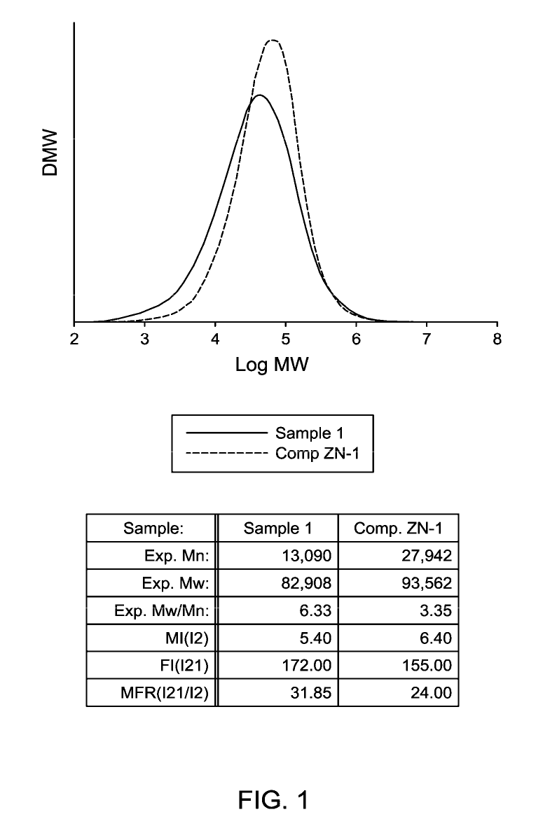

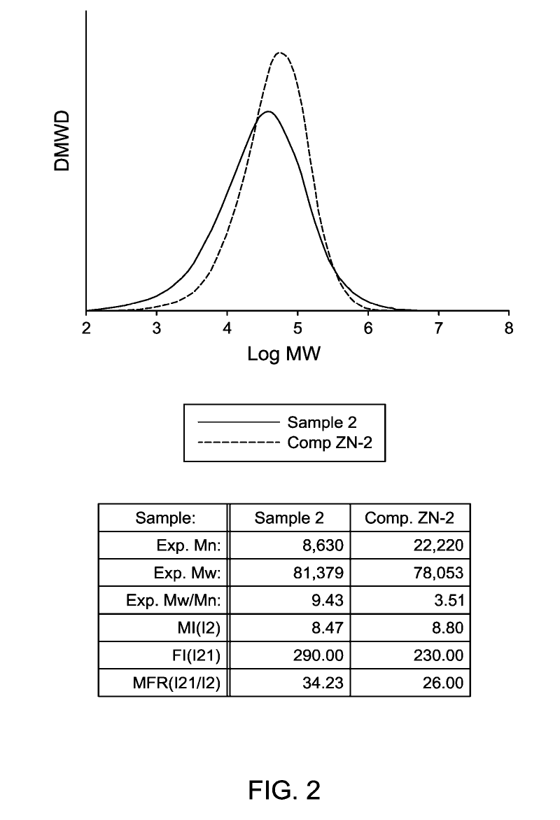

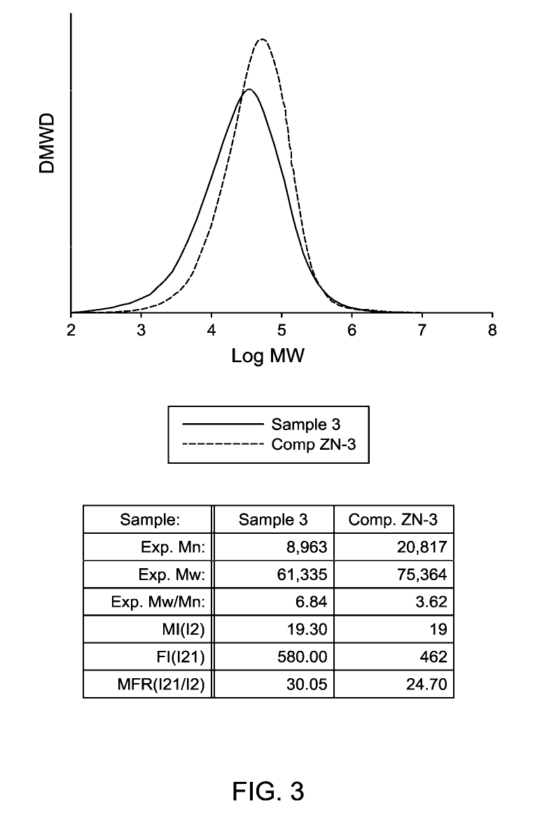

Three HDPE injection molding grades were polymerized using a single site Group-15 containing catalyst (Samples 1-3) and comparatively examined in terms of SEC and viscosity to their counterpart commercial products polymerized using ZN catalysts (Comp. ZN-1, Comp. ZN-2, and Comp. ZN-3). Samples 1-3 exhibited superiority in a comparative spiral flow test over the ZN-based commercial products of equivalent MI (I₂). Samples 1-3 exhibited longer hours at ESCR (F50) tested with 10% IGEPAL than those commercial ZN products of equivalent MI. The polydispersity of Samples 1-3 was 2 to 3 times broader than the counterpart ZN products, as shown in FIGS. 1-3. Samples 1-3 had higher MFRs, higher viscosities at a lower shear frequency, and lower viscosities at a higher shear frequency. Higher MWD, higher MFR, and a pronounced shear thinning behavior suggest superiority in injection moldability to its counterpart.

In Samples 1-3, the catalyst was a bis amide complex of a Group 4 metal bound to two nitrogens, particularly, the catalyst was bis(2-(pentamethyl-phenyl amido) ethyl) amine zirconium dibenzyl.

In comparative samples ZN-1 to ZN-3, the catalyst was an UCAT™ A catalyst, which was obtained from Univation Technologies, LLC, Houston, Tex.

Table 1 below shows the basic characterizations of the resins obtained from each catalyst.

TABLE 1

| | | | Comp. | | Comp. | | Comp. |
|---|---|---|---|---|---|---|---|
| GRADE | | Sample 1 | ZN-1 | Sample 2 | ZN-2 | Sample 3 | ZN-3 |
| Density | g/cm³ | 0.951 | 0.953 | 0.966 | 0.961 | 0.952 | 0.951 |
| MI(I₂) | dg/min | 5.2 | 6.5 | 8.2 | 7.9 | 18.5 | 17.7 |
| HLMI | dg/min | 169.5 | 156.6 | 290.4 | 201.3 | 540 | 415.9 |
| (I₂₁) | | | | | | | |
| MFR | I21/I2 | 32.6 | 24.1 | 35.4 | 25.4 | 29.2 | 23.5 |
| Mw | g/mol | 82900 | 93600 | 81400 | 78000 | 61300 | 75400 |
| Mn | g/mol | 13100 | 27900 | 8600 | 22200 | 9000 | 20800 |
| Mw/Mn | ratio | 6.3 | 3.4 | 9.5 | 3.5 | 6.8 | 3.6 |

TABLE 2

| ESCR F50 | | Comp. | Sample | Comp. | | Comp. |
|---|---|---|---|---|---|---|
| (Hr) | Sample 1 | ZN-1 | 2 | ZN-2 | Sample 3 | ZN-3 |
| 10% | Greater | 13 | 4 | 3 | 4 | 2 |
| IGEPAL | than 55 | | | | | |

Table 2 and Table 3 report the ESCR, spiral flow, toughness, and physical properties of the resins. Spiral flow measurements were obtained at three pressures on a 225T Husky injection-molding press. Injected molded samples were molded on 225T Husky molding equipment and tested. Toughness properties of the resins were measured as tensile impact at −40° C., notched Izod at −40° C. and 2 gallon pail drops at −20° C. The first two were on samples in accordance with the ASTM method, the latter on 2-gallon pails injection molded on the 225T Husky equipment.

TABLE 3

| | | | | | |
|---|---|---|---|---|---|
| | Comp. | | Comp. | | Comp. |
| Sample 1 | ZN-1 | Sample 2 | ZN-2 | Sample 3 | ZN-3 |

| SPIRAL FLOW | | | | | | | |
|---|---|---|---|---|---|---|---|
| 700 PSI | in | 16.6 | 15.6 | 20.9 | 17.5 | 26.6 | 23.2 |
| 1200 PSI | in | 26.7 | 24.6 | 33.1 | 28.0 | 39.8 | 35.2 |
| 1700 PSI | in | 32.8 | 31.5 | 40.7 | 36.0 | 46.3 | 41.7 |
| TOUGHNESS | | | | | | | |
| TEN IMP −40 C. | ft-lbf/in² | 54.0 | 56.1 | 47.3 | 50.5 | 27.4 | 42.8 |
| IZOD −40 C. | ft-lbf/in | 1.1 | 1.3 | 1.3 | 1.7 | 0.9 | 1.0 |
| PAIL DROP −20° C. | ft | 7.8 | 7.5 | 6.6 | 8.1 | 3.8 | 4.0 |
| PHYSICAL PROPERTIES | | | | | | | |
| YIELD STRESS | psi | 3420 | 3500 | 4315 | 4220 | 3610 | 3535 |
| BREAK STRESS | psi | 2010 | 1980 | 2260 | 2060 | 1775 | 1790 |
| BREAK STRAIN | % | 65 | 65 | 40 | 50 | 50 | 50 |
| 1% FLEX MOD | psi | 133300 | 121200 | 170200 | 155100 | 127000 | 120800 |
| HDT 66 PSI | ° C. | 62.6 | 65.8 | 68.2 | 73.0 | 63.8 | 65.4 |
| HDT 264 PSI | ° C. | 40.2 | 39.5 | 42.4 | 43.2 | 40.3 | 39.7 |
| VICAT | ° C. | 125.1 | 124.0 | 125.4 | 127.5 | 122.8 | 122.3 |

The tensile properties and the heat distortion temperature (HDT) were measured according to ASTM D-638. The Vicat softening temperatures were determined according to ASTM D1525-07. The 1% flexural modulus was determined according to ASTM D-790.

Based on the MFR and MWD results, all of the Samples 1-3 were considerably broader in molecular weight distribution than their ZN catalyzed counterparts. With both higher MFR and MWD, the processability of the resin will greatly improve to produce injection molded articles.

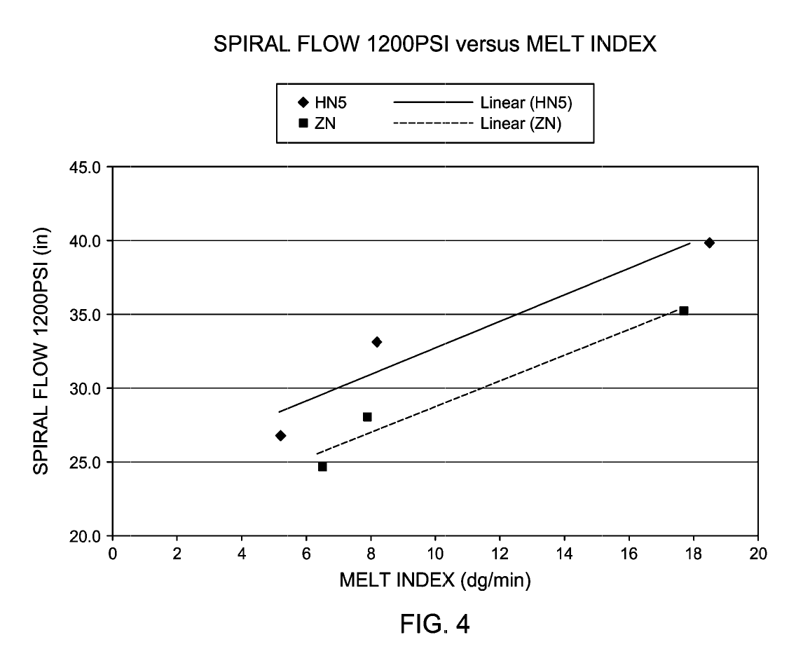

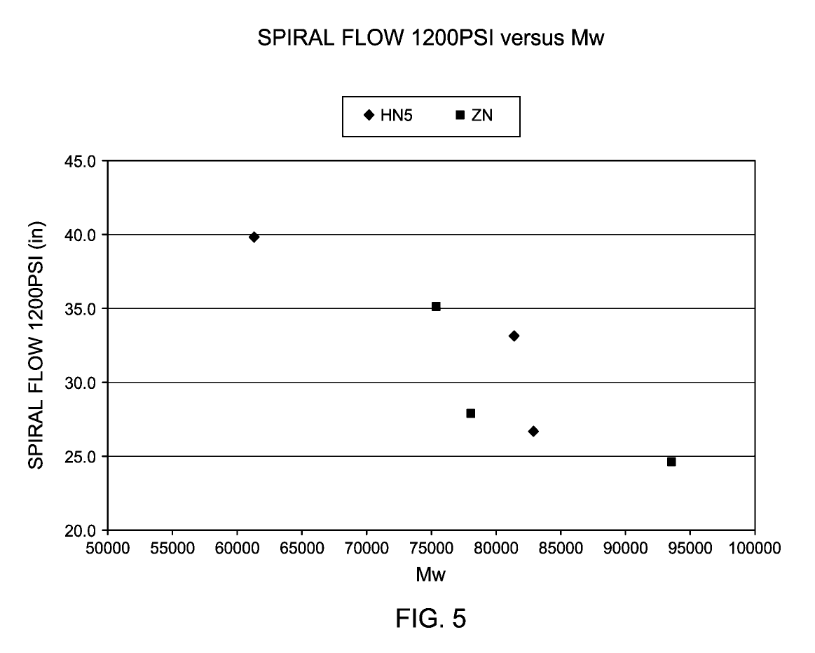

FIG. 4 shows a plot of spiral flow versus MI at an intermediate pressure indicating that at equivalent MI, Samples 1-3 have a greater spiral flow, and thus, they are easier to process, resulting from the broader MWD's. FIG. 5 is a plot of Mw versus the spiral flow.

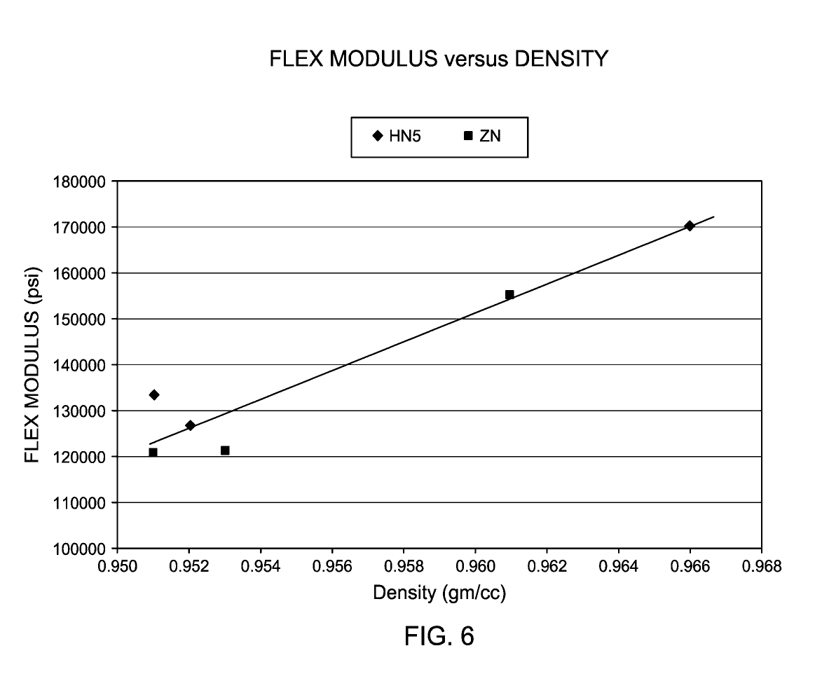

FIG. 6 is a plot of density versus flex modulus and indicates no discernable differences between the two resin types and a reasonable correlation of flex modulus with density.

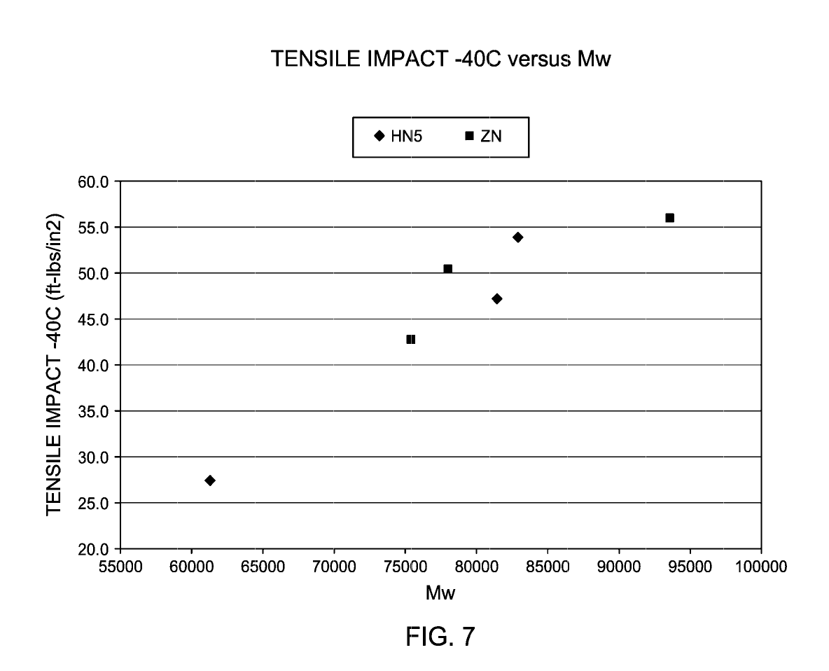

FIG. 7 is a plot of tensile impact at −40° C. versus Mw.

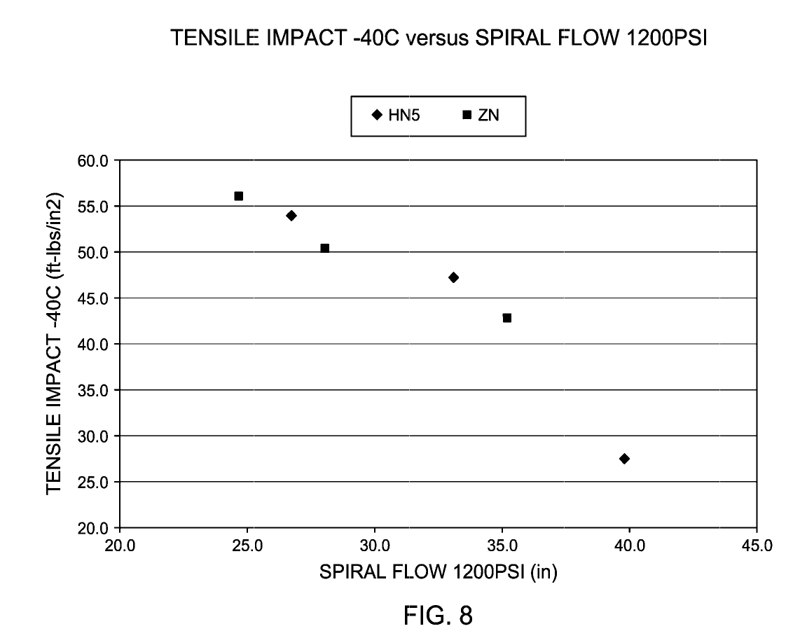

FIG. 8 is a plot of tensile impact at −40° C. versus spiral flow.

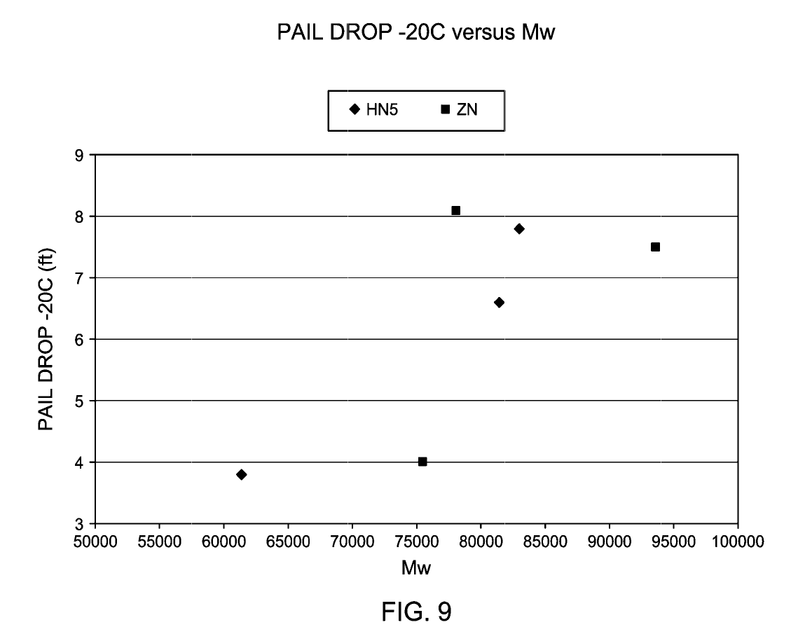

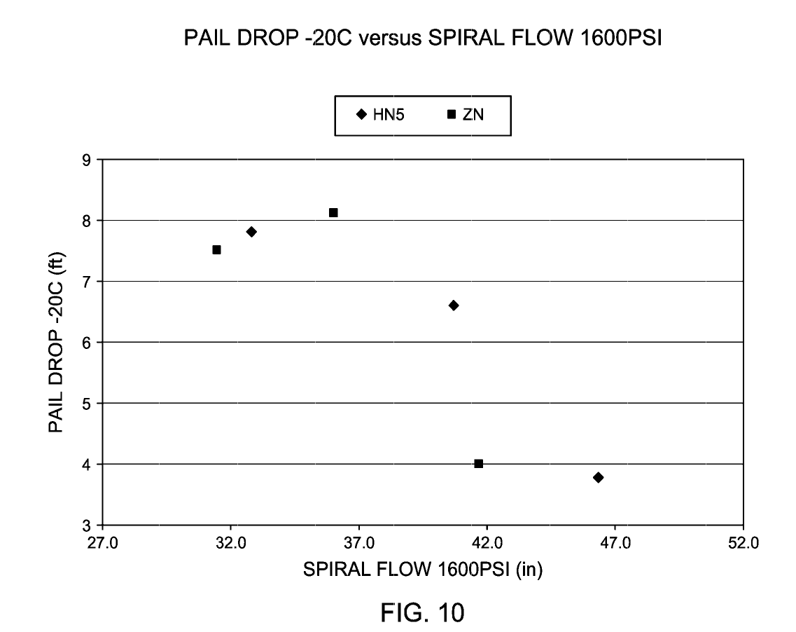

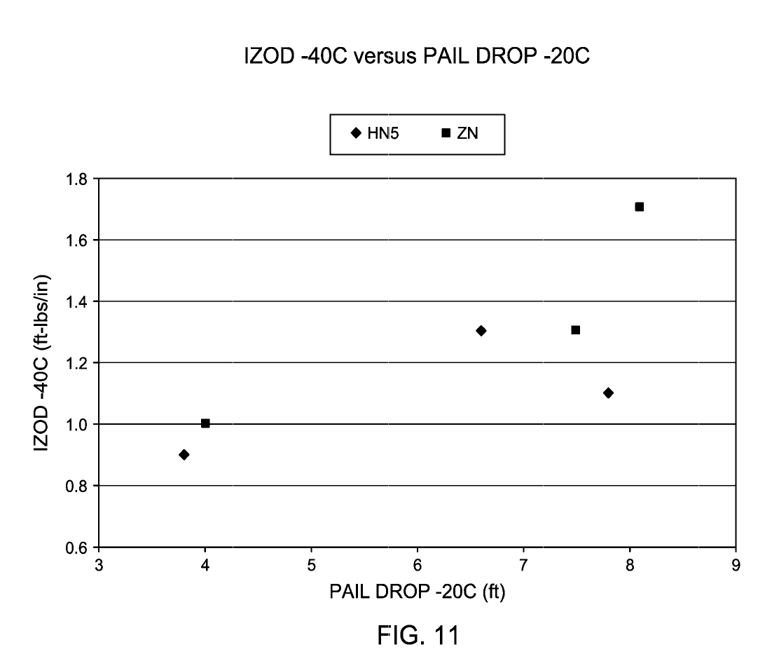

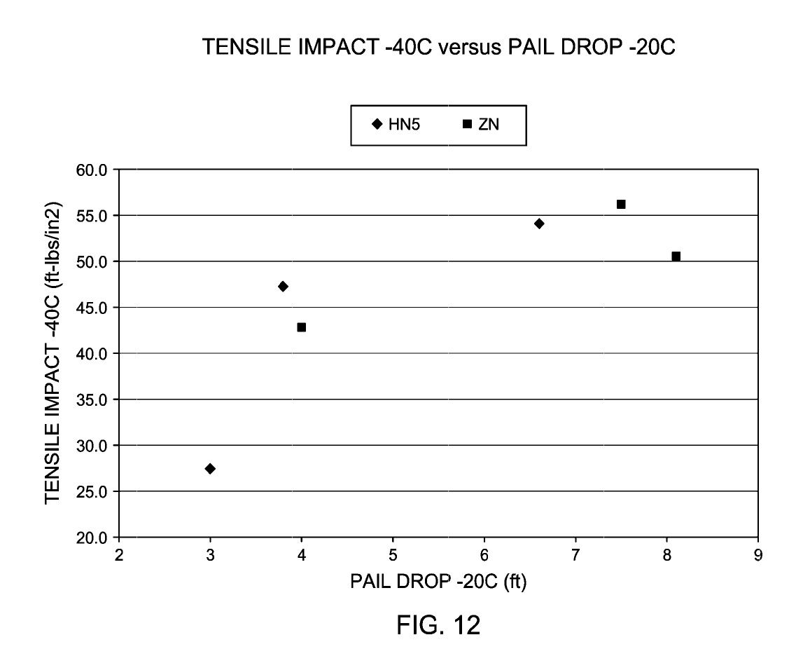

FIGS. 9-12 are plots comparing pail drop to Mw (FIG. 9), spiral flow at 1600 psi (FIG. 10), IZOD (FIG. 11), and tensile impact (FIG. 12).

The phrases, unless otherwise specified, “consists essentially of” and “consisting essentially of” do not exclude the presence of other steps, elements, or materials, whether or not, specifically mentioned in this specification, so long as such steps, elements, or materials, do not affect the basic and novel characteristics of the invention, additionally, they do not exclude impurities and variances normally associated with the elements and materials used.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

All priority documents are herein fully incorporated by reference for all jurisdictions in which such incorporation is permitted and to the extent such disclosure is consistent with the description of the present invention. Further, all documents and references cited herein, including testing procedures, publications, patents, journal articles, etc., are herein fully incorporated by reference for all jurisdictions in which such incorporation is permitted and to the extent such disclosure is consistent with the description of the present invention.

While the invention has been described with respect to a number of embodiments and examples, those skilled in the art, having benefit of this disclosure, will appreciate that other embodiments can be devised which do not depart from the scope and spirit of the invention as disclosed herein.

What is claimed is:

1. A method for making a high density polyethylene composition, the method comprising:
contacting ethylene and at least one non-ethylene comonomer with a catalyst system in a gas phase reactor in the presence of hydrogen at an ethylene partial pressure of 100 psi or more to produce a polyethylene copolymer having:
a density of about 0.945 g/cm³ or more;
a melt index (I₂) of about 5 dg/min to about 50 dg/min;
a melt flow ratio (I₂₁/I₂) of about 20 to about 35;
a molecular weight distribution of about 3.0 to about 10; and
a spiral flow in accordance with ASTM D 3123-98 at 1,200 psi injection pressure that is greater than 0.90*MI (I₂)+21 inches, and recovering the polyethylene copolymer; and
wherein the catalyst system comprises bis amides.

2. The method of claim 1, wherein the catalyst system comprises fumed silica with methylalumoxane.

3. The method of claim 1, wherein the density of the polyethylene copolymer is from 0.950 g/cm³ or more.

4. The method of claim 1, wherein the density of the polyethylene copolymer is from 0.960 g/cm³ or more.

5. The method of claim 1, wherein the density of the polyethylene copolymer is from 0.950 g/cm³ to 0.970 g/cm³.

6. The method of claim 1, wherein the density of the polyethylene copolymer is from 0.951 g/cm³ to 0.966 g/cm³.

7. The method of claim 1, wherein the non-ethylene monomer is 1-butene, 1-hexene, or 1-octene, or mixtures thereof.

8. The method of claim 1, wherein the polyethylene copolymer has an ESCR (F50, IGEPAL 10%) of 55 hours or more.

9. The method of claim 1, wherein the bis amides comprise bis(2-(pentamethyl phenyl amido)ethyl) amine zirconium dibenzyl.

10. The method of claim 1, wherein the melt index (I₂) of the polyethylene copolymer is from about 5.0 dg/min to about 40 dg/min.

11. The method of claim 1, wherein the melt index (I₂) of the polyethylene copolymer is from about 5.0 dg/min to about 35 dg/min.

12. The method of claim 1, wherein the melt index (I₂) of the polyethylene copolymer is from about 5.0 dg/min to about 20 dg/min.

13. The method of claim 1, wherein the melt index ratio (I₂₁/I₂) of the polyethylene copolymer is about 20 to about 35.

14. The method of claim 1, wherein the molecular weight distribution of the polyethylene copolymer is about 3.0 to about 10.

15. A method for making a high density polyethylene composition having enhanced injection moldability, the method comprising:
contacting ethylene and at least one non-ethylene comonomer with a catalyst system in a gas phase reactor in the presence of hydrogen at an ethylene partial pressure of 100 psi or more to produce a polyethylene copolymer having:
a density of about 0.945 g/cm³ or more;
a melt index (I₂) of about 5 dg/min to about 50 dg/min;
a melt flow ratio (I₂₁/I₂) of about 20 to about 35;
a molecular weight distribution of about 3.0 to about 10;
a spiral flow in accordance with ASTM D 3123-98 at 1,200 psi injection pressure that is greater than 0.89*MI (I₂)+23 inches, and recovering the polyethylene copolymer;
wherein the catalyst system comprises bis(2-(pentamethyl phenyl amido)ethyl) amine zirconium dibenzyl and is supported on fumed silica with methylalumoxane.

16. The method of claim 15, wherein the density of the polyethylene copolymer is about 0.951 g/cm³ to about 0.966 g/cm³.

17. The method of claim 15, wherein the melt index (I2) of the polyethylene copolymer is about 5 dg/min to about 20 dg/min.

18. The method of claim 15, wherein the melt index ratio (I₂₁/I₂) of the polyethylene copolymer is about 20 to about 35.

19. The method of claim 15, wherein the molecular weight distribution of the polyethylene copolymer is about 3.0 to about 10.

20. A method for making a high density polyethylene composition, the method comprising:
contacting ethylene and at least one non-ethylene comonomer with a catalyst system in a gas phase reactor in the presence of hydrogen at an ethylene partial pressure of 100 psi or more to produce a polyethylene copolymer having:
a density of about 0.95 g/cm³ to about 0.97 g/cm³;
a melt index (I₂) of about 5.0 dg/min to about 19 dg/min;
a melt flow ratio (I₂₁/I₂) of about 29 to about 35;
a molecular weight distribution of about 6.0 to about 9.5;
a spiral flow in accordance with ASTM D 3123-98 at 1,200 psi injection pressure that is greater than 0.89*MI (I₂)+23 inches, and recovering the polyethylene copolymer;
wherein the catalyst system comprises bis(2-(pentamethyl phenyl amido)ethyl) amine zirconium dibenzyl and is supported on fumed silica with methylalumoxane.

21. A polymer produced by the method of claim 1.

22. An injection molded article made from the polymer of claim 21.
